(19) United States
(12) Patent Application Publication
(10) Pub. No.: US 2022/0204403 A1
(43) Pub. Date: Jun. 30, 2022

(54) PRODUCTION METHOD FOR PRODUCING CEMENT AND CO-PRODUCING SULFURIC ACID FROM PHOSPHOGYPSUM

(71) Applicant: CHENGDU QIANLIJIN TECHNOLOGICAL INNOVATION CO., LTD., CHENGDU (CN)

(72) Inventor: Jiazhu GONG, CHENGDU (CN)

(21) Appl. No.: 17/152,775

(22) Filed: Jan. 19, 2021

(30) Foreign Application Priority Data
Dec. 30, 2020 (CN) 202011212325.7

(51) Int. Cl. C04B 7/43; C01B 17/74; C04B 7/24; C04B 7/45; C04B 7/47; C04B 7/48

(52) U.S. Cl. CPC C04B 7/434; C01B 17/745; C04B 7/48; C04B 7/45; C04B 7/47; C04B 7/24

(57) ABSTRACT

The disclosure discloses a production method for producing cement and co-producing sulfuric acid from phosphogypsum. The method includes: pretreating and purifying the phosphogypsum to reduce insoluble phosphorus, water-soluble phosphorus impurities, and most free water in the phosphogypsum, directly feeding the materials kneaded and granulated with a reducing agent into a reduction and decomposition integrated rotary kiln with a fluidized preheating function, and controlling to carry out step-by-step heating, drying, dehydration, reduction and decomposition in a gas phase atmosphere under pulverized coal combustion; using sulfur dioxide gas generated after reduction and decomposition to produce the sulfuric acid after dust removal and purification; making the materials after reduction and decomposition enter an oxidation calcining kiln for sintering a cement clinker, and controlling to heat, mineralize and sinter the cement clinker in the gas phase atmosphere under the pulverized coal combustion.

### CROSS-REFERENCE TO RELATED APPLICATIONS

This application claims priority to Chinese Patent Application No. 202011212325.7 with a filing date of Dec. 30, 2020. The content of the aforementioned applications, including any intervening amendments thereto, are incorporated herein by reference.

### TECHNICAL FIELD

The present invention relates to a production method for producing cement and sulfuric acid from gypsum, and more particularly, to a production method for producing cement and co-producing sulfuric acid from phosphogypsum.

### BACKGROUND

Phosphogypsum is produced by precipitation and crystallization of phosphorite and sulfuric acid subjected to a double decomposition reaction during wet-process phosphoric acid production, with a chemical reaction principle as follows:

Ca₅F(PO₄)₅+H₂SO₄+10H₂O→3H₃PO₄+5CaSO₄.2H₂O↓+HF↑

Production of 1 ton of wet-process phosphoric acid (P₂O₅%) generates 5 to 6 tons of solid phosphogypsum. There are about 5 billion tons of solid phosphogypsum stacked on lands in the world. A lot of capitals and lands are required to build a storage yard for massive discharge of the phosphogypsum. Since the phosphogypsum is soaked in rainwater for a long time, soluble phosphorus, fluorine, and the like in the phosphogypsum are transmitted to the environment through a water body as a medium, causing pollution of soil, water system and atmosphere, even causing a large number of environmental disasters due to collapse.

The phosphogypsum is a huge industrial solid by-product necessary to be generated under current technical conditions; and two chemical elements of calcium and sulfur contained in the phosphogypsum are necessary resources for life and production. Although there are many ways to utilize the phosphogypsum, such as directly using the phosphogypsum as a building material, and manufacturing the phosphogypsum into a gypsum board, a gypsum block, a gypsum putty, and the like, the phosphogypsum has four shortcomings compared with natural gypsum or desulfurized gypsum. Firstly, in phosphorus chemical industry production, in order to achieve a best phosphorite utilization rate and make filtration and washing easier, phosphogypsum crystalline particles need to be coarse, resulting in a low specific surface area and a poor activity when used in gypsum products. Secondly, some micro soluble ingredients and residual phosphorus brought by liquid holdup of the phosphogypsum may have salt efflorescence and mildew due to a change of a humidity in air after entering the gypsum products. Thirdly, except for constant calcium, sulfur and silicon ingredients contained in the phosphogypsum, contents of micro and ultra-micro impurities in the phosphogypsum are different due to different mineral sources, resulting in endless changes in differences in morphology, specific surface, and reactivity of the produced phosphogypsum. Fourthly, in wet-process phosphoric acid production which is a previous process of phosphogypsum production, a grinding fineness of the phosphorite brings influences of original undecomposed phosphorite particles and acid-insoluble particles. Fifthly, it is unprofitable due to an economic value limitation brought by a low inherent economic value of the gypsum products and a transportation cost of the gypsum products.

Therefore, sulfuric acid and cement are produced with calcium and sulfur elements in the phosphogypsum according to a principle of reduction, recycling, and reuse of a recycling economy. The sulfuric acid is recycled to a wet-process phosphoric acid device, so that sulfur resources are recycled, and the calcium element is used in cement production, which reduces exploitation of lime mine, and saves exploitation of primary calcium resources, thus being a best recycling economy method and a practical and effective way to maximize resource utilization. It is also a “knot” that people have diligently and continuously worked hard and failed in development of a generation technology in the past 100 years.

In 1915, German Müller used carbon as a reducing agent, and added Al₂O₂, Fe₂O₃, and SiO₂ into the gypsum to decompose at a high temperature. Decomposed CaO reacted with an added oxide to form a cement clinker, and decomposed SO₂ gas was used for producing the sulfuric acid. Afterwards, Kühne made a research and put it into industrial production on this basis. In 1916, Bayer Fuel Company of Germany built a plant for manufacturing sulfuric acid and cement from gypsum in Germany, and normal production was carried out in 1931. It is a technology called Müller-Küller method (M-K method) or a Bayer method for producing the cement and co-producing the sulfuric acid from the gypsum. In 1968, Linz Chemical Company of Austria used the phosphogypsum instead of natural gypsum to successfully operate on a 200 t/day sulphuric acid device by the Müller-Küller technology. In order to reduce energy consumption, a vertical cylindrical preheater was additionally arranged at a tail part of a rotary kiln in 1972, which achieved a good energy saving effect, and reduced heat consumption by 15% to 20%. It is a technology called an Osw-KPupp method (O-K method) for producing the cement and co-producing the sulfuric acid from the gypsum.

Although preheating outside the kiln is used in the Osw-KPupp technology, which utilizes sensible heat in tail gas of calcination and decomposition, coal consumption of a production device thereof is still high, a concentration of SO₂ gas in the tail gas is low, a quality of the cement is poor, a production process is difficult to be controlled, and an efficiency of the production device is low. Compared with the production of the cement from limestone mine, an energy consumption index of an excellent cement producer is a heat quantity of 2926 KJ/Kg for producing every kilogram of cement clinker, wherein a heat quantity of 1580 KJ/Kg is needed to decompose calcium carbonate, accounting for nearly 70% of the energy consumption. However, a heat quantity of 1879.26 KJ/Kg is needed to decompose anhydrous gypsum, which is only 1.7 times of the heat consumption for decomposing the calcium carbonate according to calcium oxide per kilogram of cement clinker generated, while actual total energy consumption is more than 4 times higher.

A reaction principle of producing the cement and the sulfuric acid from the phosphogypsum is as follows:

CaSO₄+2C═CaS+2CO₂↑ (1)

3CaSO₄+CaS=4CaO+4SO₂↑ (2)

CaO+(SiO₂,Al₂O₃,Fe₂O₃)→calcium silicate+calcium aluminoferrite, etc. (3)

CaSO₄+3CaS=4CaO+4S (4)

C+O₂═CO₂↑ (5)

S+O₂═SO₂↑ (6)

The reaction formulas (1) and (2) are reduction and decomposition reactions, and the reaction formula (3) is a mineralization and sintering reaction for producing the cement, which is a main reaction needed in production, while the reaction formulas (4) to (6) are side reactions during production. The former two reactions and the latter two reactions determine a difficulty and a practical economy of the production device. In principle, the main reaction is a semi-reduction and decomposition reaction according to the reaction formulas (1)+(2), hexavalent sulfur in the calcium sulfate is reduced to tetravalent sulfur with elemental carbon, and a half molecule of carbon is needed for reducing one molecule of SO₂. A combined reaction formula thereof is:

CaSO₄+0.5C═CaO+SO₂↑+0.5CO₂↑ (7)

In the case of the side reactions, a deep reduction and decomposition reaction is carried out according to the reaction formulas (1)+(4)+(6), and one and a half molecules of carbon is needed to obtain one molecule of SO₂, which is three times that of the main reaction. A combined reaction formula thereof is:

CaSO₄+1.5C+O₂═CaO+SO₂↑+1.5CO₂↑ (8)

If the side reactions are mainly focused, not only a production cost is high, but also a concentration of the sulfur dioxide gas of a production index and ingredients of the cement clinker are difficult to be controlled.

Moreover, according to a decomposition reaction condition of the phosphogypsum, the generated sulfur dioxide is related to a reaction temperature and a gas phase atmosphere of the reaction. As shown in FIG. 1, the reaction temperature is directly proportional to a decomposition rate, and a content of oxygen (log pO₂) in the reaction atmosphere is inversely proportional to the decomposition rate. However, if the content of the oxygen is too low, the reactants will enter a CaS area in an upper left corner, especially on an interface between reduced carbon powder particles and phosphogypsum powder particles, even a large amount of CaS is wrapped and generated in the cement clinker. The hydrogen sulfide gas is released when mixing with water during use, which affects the environment and operation. In addition, an elemental substance S generated by the reaction formula (4) starts to be sublimated into gas before reaching the decomposition temperature of the phosphogypsum, and enters the cooling section to be solidified, thus blocking the system.

Therefore, a cement clinker index cannot meet a basic requirement: a cement clinker control index requires that free CaO(F—CaO) is lower than 1.5% (an actual requirement is lower than or equal to 1.2), CaS is lower than 1.0%, SO₃ is lower than 1.5%, and actual production is 1.89% of free CaO, 1.53% of CaS, 2.42% of SO₃, or even higher. It is impossible to produce high-quality cement clinker products, and early cement strength indexes of “3 days, 28 days” are difficult to be controlled stably. If the content of the oxygen is high, not only the concentration of decomposed SO₂ gas generated from the kiln tail is low, but also the co-production of the sulfuric acid is unfavorable, so that an efficiency of the plant is low. These shortcomings cannot be overcome by an existing technology. It is also the difficulty that the existing production technology for producing the cement and the sulfuric acid from phosphogypsum cannot be industrialized in the face of such huge phosphogypsum output, an environmental protection pressure, and requirements of sustainable development and resource conservation.

Therefore, in order to control an atmosphere for reduction and decomposition as well as oxidizing calcination, Chinese patents ZL 201310437466.3 and ZL201410070462.0 feed powdered raw materials after drying phosphogypsum, which are suspended and preheated by a multi-stage suspension preheater, and reduced and decomposed to be separated from an oxidizing calcination combustor, and a certain progress is made. However, there are three shortcomings. Firstly, high free water of the phosphogypsum needs to be dried in advance, which consumes energy, and residual phosphorus (including water-soluble phosphorus and insoluble phosphorus) in the phosphogypsum seriously affects a cement sintering reaction. Secondly, dry phosphogypsum powder and reduced coal powder are mixed and enter the suspension preheater for preheating, resulting in ineffective combustion of reducing pulverized coal on a heat transfer surface, with high investment on the suspension preheater and increased power consumption required for production, and the energy consumption is not optimal. Thirdly, for a mixed powder material entering a reduction and decomposition ring kiln, with rotation of the rotary kiln, high-temperature gas is very easy to take up the reduced coal powder on a bare surface of the material and burn it quickly, so that not only an effect of reducing pulverized coal is not achieved, but also a lot of air is consumed.

U.S. Pat. No. 4,608,238 “Method for Treating Waste By-products of Phosphogypsum of Wet-process Phosphoric Acid” includes removing fluorine and phosphorus from the phosphogypsum, pre-drying, then reducing and decomposing at 1,050° C., heating a material at 1,200° C. to 1,250° C. with an excessive oxygen atmosphere, and then heating the material at 1,650° C. with an electric furnace to obtain silicate lime. The same shortcomings of the technology are as follows. Firstly, a process is long. Secondly, the phosphogypsum comes from a phosphoric acid filter with a high water content, and requires coal consumption for drying, which is as insufficient as the drying of the Chinese patents ZL201310437466.3 and ZL201410070462.0. Thirdly, the fluorine and the phosphorus in the phosphogypsum are high in content, and are passively removed by the oxidation electric furnace at a high temperature instead of removing in advance, and a heat source of the electric furnace is low in efficiency and high in energy consumption as secondary energy. Fourthly, a step grid furnace is used, with a high mass and heat transfer efficiency, and large power consumption.

According to a method of the U.S. Pat. No. 6,395,246 “preparation of calcium silicate and sulfur dioxide”, carbon is not used as a reducing agent to decompose the phosphogypsum, and the phosphogypsum is directly mixed with silicon dioxide, heated to 1,538° C., and sprayed with 2% to 5% water to generate “new ecological” hydrogen and oxygen, and the intermediate silicic acid is generated, and then decomposed with the phosphogypsum into the calcium silicate and the sulfur dioxide. Water has been vaporized before getting close to an object at a high temperature, thus being difficult to enter a semi-molten solid material, and a difficulty in generating new ecological silicic acid (H₂SiOₓ) by hot melting the silicon oxide in solid is obvious.

### SUMMARY

In order to overcome the above shortcomings, the disclosure aims to provide a coupling production method for producing cement and co-producing sulfuric acid from phosphogypsum. The method includes: pretreating and purifying the phosphogypsum to reduce most insoluble phosphorus, water-soluble phosphorus, and large-particle silicon impurities (acid non-soluble substances) in the phosphogypsum, carrying out non-thermodynamic (mechanical) dehydration, then directly feeding the materials kneaded and granulated with a reducing agent into a reduction and decomposition integrated rotary kiln with fluidized preheating, drying and dehydration, and controlling to carry out step-by-step fluidized heating of reverse flow, fluidized drying, fluidized dehydration, reduction and decomposition in a low-oxygen-content atmosphere under pulverized coal combustion; using gas generated after reduction and decomposition to produce the sulfuric acid after dust removal and purification; making the materials after reduction and decomposition enter an oxidation calcining kiln for sintering a cement clinker, and controlling to heat and calcine cement clinker products in a high-oxygen-content atmosphere under the pulverized coal combustion. According to the method, in a process of removing phosphogypsum impurities in advance, mechanical dehydration is used, without separate drying to remove free water in the phosphogypsum, thus saving drying fuel, reducing consumption of reducing coal and sintering coal, improving a product quality of the cement clinker, and achieving purposes of energy saving, production cost reduction, production efficiency improvement, investment reduction, and economic benefit increase of a producer. An environmental protection problem of phosphogypsum stacking treatment is eliminated.

The disclosure has the technical solution that: a production method for producing cement and co-producing sulfuric acid from phosphogypsum includes: feeding phosphogypsum containing a large amount of free water discharged from a vacuum filter for phosphoric acid production into a pulping tank for pulping;

feeding pulp materials into a gravity classifier to separate coarse particles, and making the coarse particles return to an ore grinding system of the phosphoric acid production; making the materials with the coarse particles separated enter a filter press for filtration, pressure dehydration and blow drying, and recycling a filtrate to the phosphoric acid production as a process water supplement; feeding a filter cake into a granulator to be granulated with added reducing pulverized coal and supplemented auxiliary material;

using the granulated materials as cement raw materials to enter a reduction and decomposition integrated rotary kiln with a fluidized preheating device, and controlling to carry out fluidized heating of reverse flow, fluidized drying, fluidized dehydration, reduction and decomposition in a low-oxygen-content atmosphere under pulverized coal combustion; using decomposed gas sulfur dioxide generated after reduction and decomposition to produce the sulfuric acid after dust removal and purification; and

making the reduced and decomposed materials enter a cement clinker sintering kiln, controlling a high-oxygen-content atmosphere under the pulverized coal combustion, and increasing a temperature to heat and sinter the cement clinker products.

Preferably, a pulping ratio of the phosphogypsum to the water is 1:2 to 4, and preferably 1:2.5.

Preferably, after the phosphogypsum slurry is added into a gravity separator and separated, a total amount of separated coarse particles is 2% to 8%, and preferably 5%.

Preferably, the free water of the phosphogypsum subjected to the pressure dehydration is 8% to 15%, and preferably 10% to 12%.

Preferably, the filter cake of the dehydrated phosphogypsum is granulated with reducing pulverized coal and clay, and a kneading granulator is preferably used as a granulator.

Preferably, the reduction and decomposition integrated rotary kiln with fluidized preheating, drying and dehydration is an integral cylindrical rotary kiln, as shown in FIG. 2, the fluidized preheating, drying and dehydration section is provided with a special-type shoveling plate for lifting, so that the materials are shovelled when the rotary kiln rotates, and the materials are lifted from low to high along with the rotation, and after reaching a certain rotation angle, the materials start to be scattered gradually; the fluidized materials are heated by contacting with high-temperature gas reversely flowing in the kiln, dried and dehydrated, and meanwhile, the high-temperature gas is cooled; a setting area of the special-type shoveling plate for lifting is 0.2 L to 0.5 L, preferably 0.3 L to 0.4 L of a total length of the kiln; the special-type shoveling plates for lifting are capable of being respectively arranged at intervals of an a-type shoveling plate, a b-type shoveling plate, and a c-type shoveling plate, and preferably, the b-type shoveling plate and the c-type shoveling plate are arranged at an interval on a circumference; and refractory bricks are laid for high-temperature reduction and decomposition, and a setting area of the refractory bricks is 0.8 L to 0.5 L, and preferably 0.7 L to 0.6 L of the total length of the kiln, thus maintaining reasonable material residence time.

Preferably, the material from a kiln outlet of the reduction and decomposition kiln directly enters the cement clinker sintering rotary kiln, and a diameter of the sintering rotary kiln is 0.5 to 0.7 times, and preferably 0.4 to 0.6 times a diameter ϕ of the reduction and decomposition rotary kiln.

Preferably, gas generated by sintering in the cement clinker sintering rotary kiln enters the reduction and decomposition rotary kiln; and the cement clinker enters a cooler and is cooled with air to prepare the cement.

Preferably, a temperature of the sulfur oxide gas discharged from a kiln tail of the reduction and decomposition rotary kiln after reduction and decomposition, fluidized preheating, drying, and dehydration is 320° C. to 400° C., and preferably 330° C. to 350° C. A content of O₂ in the sulfur oxide gas is 0 to 1.0%, and preferably 0.2% to 0.6%.

Preferably, a temperature of the decomposition section of the reduction and decomposition rotary kiln is 1,000° C. to 1,200° C., and preferably 1,050° C. to 1,150° C.

Preferably, a temperature of the sintering section of the cement clinker sintering kiln is 1,250° C. to 1,450° C., and preferably 1,300° C. to 1,350° C.; and a content of O₂ in outlet gas of the cement clinker sintering kiln is 1.0% to 4.0%, and preferably 2.0% to 3.0%.

Preferably, an excess air coefficient in the cement clinker sintering kiln is 1.06.

Preferably, the cement clinker is cooled from 1,150° C. to 110° C.-160° C., and preferably to 110° C.-130° C.

Compared with the prior art, the present invention has the principles and beneficial effects as follows.

According to the disclosure, the phosphogypsum containing high free water, water-soluble phosphorus and insoluble phosphorus separated by a vacuum filter in wet-process phosphoric acid production is directly added with the water for pulping, coarse-particle insoluble phosphorus in the phosphogypsum is separated by a gravity, and then the phosphogypsum is fed into the pressure filter for filtration separation, extrusion and air blowing, so that the contents of the free water and the water-soluble phosphorus in the phosphogypsum are reduced; then the phosphogypsum is kneaded and granulated with the reducing agent and the auxiliary material, so that the reducing agent and the auxiliary material are tightly kneaded with the phosphogypsum, which is beneficial for an oxygen deprivation reaction of the reducing carbon and a sulfate radical in gypsum; the granulated materials are fed into the reduction and decomposition integrated rotary kiln with fluidized preheating, drying and dehydration, which overcomes shortcomings of high reducing agent consumption, low thermal efficiency and high investment price of an original suspension preheater; and the reduced and decomposed materials enter an oxidation sintering rotary kiln with smaller specification and size, and the higher-oxygen-content atmosphere is controlled, so that the rotary kiln has a large filling coefficient, a thermal efficiency and a production efficiency are high, CaS in cement products is low, and a quality of products is high. Energy consumption for drying the free water of the phosphogypsum is saved, consumption of reducing coal and sintering coal is reduced, purposes of energy saving, production cost reduction, production capacity improvement, quality optimization of cement products, investment reduction, and economic benefit increase of a producer are achieved, and an environmental protection problem of phosphogypsum stacking treatment is eliminated.

According to the disclosure, pulping, purification, extrusion and blowing dehydration (non-thermodynamic dehydration) of the phosphogypsum are employed, the phosphogypsum is kneaded and granulated with the reducing agent, and a series of manners like the integrated rotary kiln for preheating, drying, dehydration, reduction and decomposition of fluidized materials and the oxidation sintering efficiency rotary kiln are used in the method for producing the cement and co-producing the sulfuric acid from the phosphogypsum, so that the existing technology for producing the cement and co-producing the sulfuric acid from the phosphogypsum is optimized and upgraded; by utilizing thermodynamic and kinetic characteristics of the reduction and decomposition of the cement sintering, and the optimum process parameters of kneading and granulation, fluidized preheating and drying, reduction and decomposition in the low-oxygen-content atmosphere, and mineralization and calcination in the high-oxygen-content atmosphere, the energy consumption of production is greatly reduced, the production capacity of the device is greatly increased, and the technological production is stable and easy to be controlled; a concentration of the gas sulfur oxide has small fluctuation, and the quality of the cement products is stable and excellent; purposes of saving energy, reducing the production costs, improving the production efficiency, reducing investment, and increasing economic benefits increase of a producer are achieved, and the environmental protection problem of phosphogypsum stacking treatment is eliminated. Therefore, the disclosure not only can use the phosphogypsum as a calcium and sulfur resource, but also has the advantages of low processing cost, remarkable economic and social benefits, and the like.

In the disclosure, the pulping ratio of the phosphogypsum from phosphoric acid production to the water is 1:2 to 4, and preferably 1:2.5; the total amount of separated coarse particles is 1% to 6%, and preferably 3%; the free water of the phosphogypsum subjected to the pressure dehydration is 8% to 15%, and preferably 10% to 12%; the filter cake of the dehydrated phosphogypsum is granulated with the reducing pulverized coal and the clay, and the kneading granulator is preferably used as the granulator; for the integrated rotary kiln for fluidized preheating, dehydration, drying, reduction and decomposition, a length L1 of the special-type shoveling plate for lifting is set to be 0.2 to 0.5 times, preferably 0.3 to 0.4 times the total length L of the kiln; the diameter of the sintering rotary kiln is 0.5 to 0.7 times, and preferably 0.4 to 0.6 times the diameter ϕ of the reduction and decomposition rotary kiln, with the length l of 0.4 L to 0.6 L; the temperature of the sulfur oxide gas discharged from the kiln tail of the integrated rotary kiln for fluidized preheating, drying, dehydration, reduction and decomposition is 320° C. to 400° C., and preferably 330° C. to 350° C., wherein the content of O₂ in the sulfur oxide gas is 0 to 1.0%, and preferably 0.2°/o to 0.6%; the temperature of the decomposition section of the reduction and decomposition rotary kiln is 1,000° C. to 1,200° C., and preferably 1,050° C. to 1,150° C.; the temperature of the sintering section of the sintering rotary kiln is 1,250° C. to 1,450° C., and preferably 1,300° C. to 1,350° C., wherein the content of O₂ in the outlet gas of the kiln is 1.0% to 4.0%, and preferably 2.0% to 3.0%; and the cement clinker is cooled from 1,150° C. to 110° C.-160° C., and preferably to 110° C.-130° C.

The disclosure solves a technical problem that people have been eager to solve for nearly 100 years, but have never achieved commercial success.

### BRIEF DESCRIPTION OF THE DRAWINGS

FIG. 1 is a diagram showing a relationship between a decomposition temperature of phosphogypsum and gas composition of a gas phase.

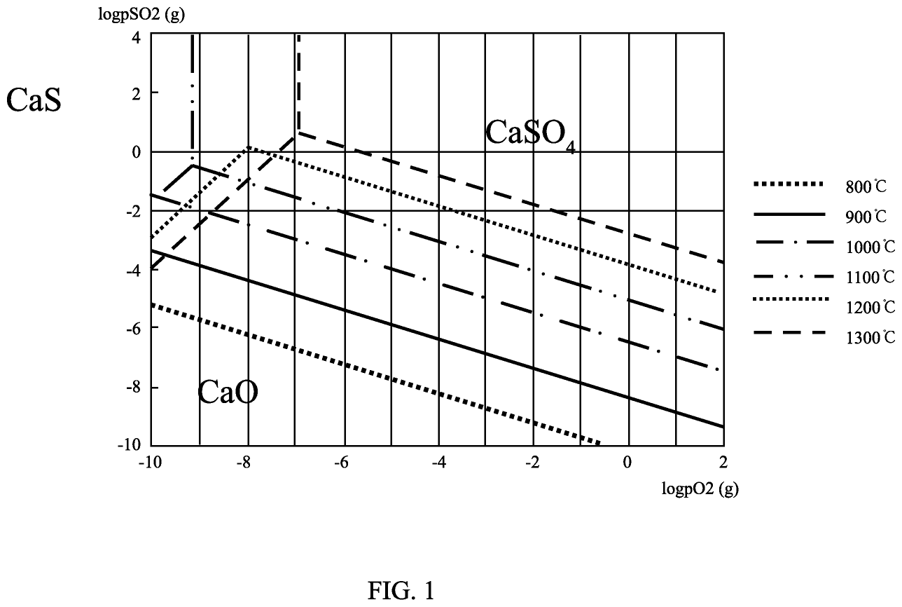

FIG. 2 is a schematic diagram of an integrated rotary kiln for fluidized preheating, drying, dehydration, reduction and decomposition of phosphogypsum according to the disclosure.

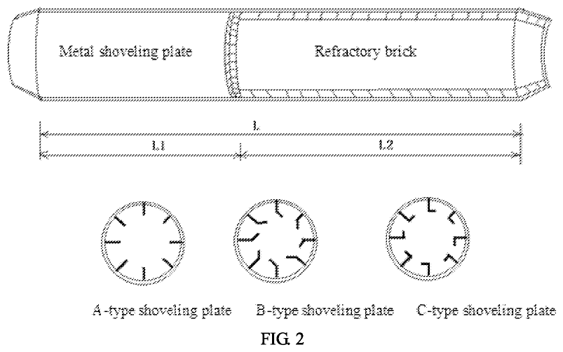

In FIG. 2, L refers to a total length of a decomposition integrated rotary kiln; L1 refers to a length of a fluidized shoveling plate for lifting; L2 refers to a set length of refractory bricks; and A, B and C-type shoveling plates refer to cross-sectional diagrams of fluidized shoveling plates for lifting arranged in the rotary kiln.

FIG. 3 is a flow chart of a technology for producing cement and co-producing sulfuric acid from phosphogypsum according to the disclosure.

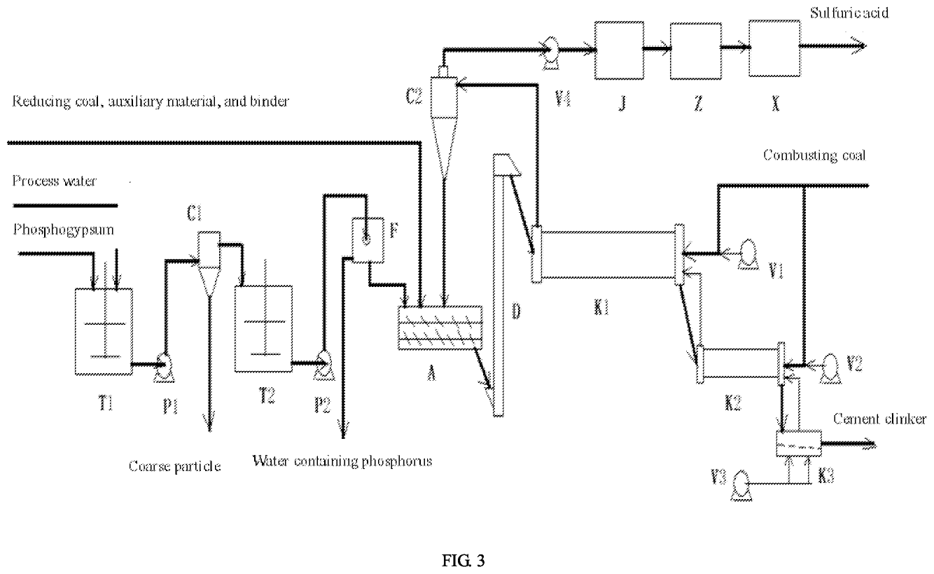

In FIG. 3, A refers to a kneading granulator; C1 refers to a separator; C2 refers to a cyclone dust collector; D refers to a bucket elevator; F refers to a filter press; J refers to a tail gas purification system; K1 refers to a reduction and decomposition integrated rotary kiln; K2 refers to a cement mineralization and sintering kiln; K3 refers to a cement cooler; P1 refers to a slurry transfer pump; P2 refers to a filter pressing feeding pump; T1 refers to a pulping tank; T2 refers to a separation storage tank; V1 refers to a reducing coal injection fan; V2 refers to a sintering coal injection fan; V3 refers to a cooling blower; V4 refers to a tail gas induced draft fan; X refers to a sulfuric acid absorption system; and Z refers to a sulfuric acid conversion system.

### DETAILED DESCRIPTION

The disclosure is further described hereinafter with reference to the accompanying drawings.

### Embodiment 1

As shown in FIG. 3, a phosphogypsum filter cake from a phosphoric acid production filter and production process water were continuously fed into a pulping tank T1 for pulping according to a ratio of 1:2.5, a pulped slurry was continuously fed into a C1 separator for separation through a pump P1, and separated coarse-particle materials were returned to a phosphorite ore grinding process of a phosphoric acid production process; a separated fine slurry entered a slurry storage tank T2, and then was fed into a filter press F through a pump P2 for filtering. A filtrate was phosphorus-containing water, and was returned to washing of the phosphogypsum filtered with phosphoric acid produced by a phosphoric acid plant. The filter cake was squeezed by a diaphragm and dried in air to obtain purified and dehydrated phosphogypsum. Compositions before and after purification refer to Table 1. After determining a ratio according to a quality requirement for producing cement and co-producing sulfuric acid, a purified phosphogypsum filter cake was fed into a kneading granulator A with a reducing agent coke and other grinded auxiliary materials for continuous kneading and granulation. After granulation, materials with an input amount of 43,500 kg per hour were lifted by an elevator D and fed into an integrated rotary K1 kiln for fluidized preheating, drying, dehydration, reduction and decomposition. Combusting pulverized coal was fed into a pulverized coal injection combustor of the integrated rotary kiln K1 by using a pulverized coal injection combustion fan V1, and a maximum temperature of materials in a decomposition section in the integrated rotary kiln K1 was controlled at 1,150° C. High-temperature gas generated by combustion and reduction and decomposition gas were jointly contacted with an overflow of the materials in the integrated kiln K1, cooled to 800° C. after gradually passing through the decomposition section, cooled to 680° C. after entering a fluidized dehydration section provided with a shoveling plate for lifting, cooled to 550° C. in a drying section, and cooled to 340° C. in a preheating section. The reduction and decomposition gas of 99,319 Nm³ was produced ever hour. Composition thereof refers to Table 2. Meanwhile, a concentration of O₂ in the decomposed gas was controlled at 0.36% with matching secondary air and high-temperature hot air tail gas discharged from a cement mineralization and sintering kiln K2. The reduction and decomposition gas was returned to a granulator A after most dust was separated by a cyclone dust collector C2, and separated gas was fed for sulfuric acid production by a fan V4, which was purified by a purification system J, converted by a conversion system Z, and prepared into the sulfuric acid by an absorption system X.

TABLE 1
Indexes of phosphogypsum before and after purification and dehydration

| Ingredient | CaO | SO₃ | SiO₂ | P₂O_{5 insoluble} | P₂O_{5 water-soluble} | Free water |
|---|---|---|---|---|---|---|
| Before purification | 22.55 | 32.10 | 4.56 | 0.37 | 0.64 | 24.40 |
| After purification | 26.45 | 38.36 | 5.45 | 0.25 | 0.03 | 12.06 |

TABLE 2
Composition table of reduction and decomposition gas

| Ingredient | CO₂ | SO₂ | N₂ | O₂ | H₂O | Density |
|---|---|---|---|---|---|---|
| Composition % | 15.37 | 9.16 | 61.18 | 0.36 | 13.82 | 1.463 |
| Remark | | | | | | Kg/Nm³ |

Reduced and decomposed high-temperature materials from the integrated rotary kiln K1 continuously entered the cement clinker sintering rotary kiln K2, and pulverized coal was fed into a pulverized coal injection combustor in the cement clinker sintering rotary kiln K2 by using a pulverized coal injection combustion fan V2 for combustion. A maximum temperature of materials in the cement clinker sintering rotary kiln K2 was controlled at 1,300° C., an excess air coefficient was controlled at 1.06 with matching secondary air of the pulverized coal injection combustion fan V2, and a concentration of O₂ in a gas phase was 3.0%. The sintered clinker from the cement clinker sintering rotary kiln K2 continuously entered a cooler K3 and was cooled to 160° C. by using a cooling blower V3. 20,000 kg of cement clinker was obtained every hour, and fed for a cement grinding process to produce finished cement. Composition thereof refers to Table 3.

TABLE 3
Composition table of cement clinker

| Ingredient | fCaO | CaS | SO₃ | C₃S | C₂S | C₃A | C₄AF |
|---|---|---|---|---|---|---|---|
| Composition % | 0.80 | 0.60 | 0.92 | 43.90 | 36.92 | 7.36 | 9.25 |
| Remark | | | | | | | |

### Embodiment 2

As shown in FIG. 3, a phosphogypsum filter cake from a phosphoric acid production filter and production process water were continuously fed into a pulping tank T1 for pulping by 1:2.0, a pulped slurry was continuously fed into a C1 separator for separation through a pump P1, and separated coarse-particle materials were returned to a phosphorite ore grinding process of a phosphoric acid production process; a separated fine slurry entered a slurry storage tank T2, and then was fed into a filter press F through a pump P2 for filtering. A filtrate was phosphorus-containing water, and was returned to washing of the phosphogypsum filtered with phosphoric acid produced by a phosphoric acid plant and supplementation of wet-grinding ore pulp. The filter cake was squeezed by a diaphragm and dried in air to obtain purified and dehydrated phosphogypsum. Compositions before and after purification refer to Table 4. After determining a ratio according to a quality requirement for producing cement and co-producing sulfuric acid, a purified phosphogypsum filter cake was fed into a kneading granulator A with a reducing agent coke and other grinded auxiliary materials for continuous kneading and granulation. After granulation, materials with an input amount of 87,000 kg per hour were lifted by an elevator D and fed into an integrated rotary kiln K1 for fluidized preheating, drying, dehydration, reduction and decomposition. Combusting pulverized coal was fed into a pulverized coal injection combustor of the integrated rotary kiln K1 by using a pulverized coal injection combustion fan V1 for injection and combustion, and a maximum temperature of materials in a decomposition section in the integrated rotary kiln K1 was controlled at 1,150° C. High-temperature gas generated by combustion and reduction and decomposition gas were jointly contacted with an overflow of the materials in the integrated kiln K1, cooled to 800° C. after gradually passing through the decomposition section, cooled to 680° C. after entering a fluidized dehydration section provided with a shoveling plate for lifting, cooled to 550° C. in a drying section, and cooled to 340° C. in a preheating section. The reduction and decomposition gas of 1,180,153 Nm³ was produced ever hour. Composition thereof refers to Table 5. Meanwhile, a concentration of O₂ in the decomposed gas was controlled at 0.50% with matching secondary air and high-temperature hot air tail gas discharged from a cement mineralization and sintering kiln K2.

Reduced and decomposed high-temperature materials from the integrated rotary kiln K1 continuously entered the cement clinker sintering rotary kiln K2, and pulverized coal was fed into a pulverized coal injection combustor in the cement clinker sintering rotary kiln K2 by using a pulverized coal injection combustion fan V2 for injection and combustion. A maximum temperature of materials in the cement clinker sintering rotary kiln K2 was controlled at 1,300° C., an excess air coefficient was controlled at 1.08 with matching secondary air of the pulverized coal injection combustion fan V2, and a concentration of O₂ in a gas phase was 3.5%. The sintered clinker from the cement clinker sintering rotary kiln K2 continuously entered a cooler K3 and was cooled to 160° C. by using a cooling blower V3. 20,000 kg of cement clinker was obtained every hour. Composition thereof refers to Table 6.

TABLE 4
Indexes of phosphogypsum before and after purification and dehydration

| Ingredient | CaO | SO₃ | SiO₂ | P₂O_{5 insoluble} | P₂O_{5 water-soluble} | Free water |
|---|---|---|---|---|---|---|
| Before purification | 22.55 | 32.10 | 4.56 | 0.37 | 0.64 | 24.40 |
| After purification | 26.35 | 38.32 | 5.84 | 0.28 | 0.04 | 11.06 |

TABLE 5
Composition table of reduction and decomposition gas

| Ingredient | CO₂ | SO₂ | N₂ | O₂ | H₂O | Density |
|---|---|---|---|---|---|---|
| Composition % | 16.34 | 10.10 | 61.58 | 0.5 | 11.48 | 1.463 |
| Remark | | | | | | Kg/Nm³ |

Reduced and decomposed high-temperature materials from the integrated rotary kiln K1 continuously entered the cement clinker sintering rotary kiln K2, and pulverized coal was fed into a pulverized coal injection combustor in the cement clinker sintering rotary kiln K2 by using a pulverized coal injection combustion fan V2. A maximum temperature of materials in the cement clinker sintering rotary kiln K2 was controlled at 1250° C., an excess air coefficient was controlled at 1.08 with matching secondary air of the pulverized coal injection combustion fan V2, and a concentration of O₂ in a gas phase was 3.5%. The sintered clinker from the cement clinker sintering rotary kiln K2 continuously entered a cooler K3 and was cooled to 160° C. by using a cooling blower V3. 40,000 kg of cement clinker was obtained every hour. Composition of the cement clinker refers to Table 6.

TABLE 6
Composition table of cement clinker

| Ingredient | fCaO | CaS | SO₃ | C₃S | C₂S | C₃A | C₄AF |
|---|---|---|---|---|---|---|---|
| Composition % | 0.80 | 0.42 | 1.10 | 43.8 | 36.92 | 7.36 | 9.25 |
| Remark | | | | | | | |

What is claimed is:

1. A production method for producing cement and co-producing sulfuric acid from phosphogypsum, comprising: pretreating and purifying the phosphogypsum to reduce contents of non-gypsum ingredients and most free water, then granulating with a reducing agent carbon powder and an auxiliary material, feeding the granulated materials into an integrated rotary kiln formed by preheating, drying, dehydration, reduction and decomposition for reduction and decomposition of the phosphogypsum to generate sulfur oxide gas, and making the decomposed material enter a cement clinker sintering kiln for mineralizing and sintering, wherein:
the pretreating refers to pulping with water, and then carrying out gravity separation and pressure filtration separation to remove most of the non-gypsum impurity ingredients and free water, and mechanically granulating a phosphogypsum filter cake with most impurities removed with the reducing agent carbon powder and the auxiliary material;
the mechanically granulated phosphogypsum materials are fed to an integrated reduction and decomposition kiln provided with a shoveling plate for fluidized heating, drying and dehydration, heating, reduction and decomposition are controlled to be carried out in a gas phase atmosphere under pulverized coal combustion, the materials are dehydrated and dried by reverse flow of the reduced and decomposed gas, heated and self-cooled, and then purified, converted and absorbed to produce the sulfuric acid; and
the integrally reduced and decomposed materials enter the cement clinker sintering kiln, and are controlled to be heated and sintered into a cement clinker in the gas phase atmosphere under the pulverized coal combustion.

2. The production method for producing the cement and co-producing the sulfuric acid from the phosphogypsum according to claim 1, wherein the pretreating refers to pulping with water, separating the non-gypsum impurity ingredients by a gravity and reducing the free water of the phosphogypsum filter cake by pressure filtration extrusion, and then mechanically granulating the ingredients.

3. The production method for producing the cement and co-producing the sulfuric acid from the phosphogypsum according to claim 1, wherein the integrated reduction and decomposition rotary kiln is composed of two parts, a high-temperature part is lined with a heat-resisting high-temperature material as a reduction and decomposition reaction section; and a low-temperature part is provided with different models of shoveling plates for lifting along a periphery as a fluidized heating, drying and dehydration section.

4. The production method for producing the cement and co-producing the sulfuric acid from the phosphogypsum according to claim 1, wherein the pulping ratio of the phosphogypsum to the water in the pretreating and purifying is 1:2 to 4, and preferably 1:2.5; after the phosphogypsum slurry is subjected to the gravity separation, a total amount of separated coarse particles is 2% to 8%, and preferably 5%; the free water of the phosphogypsum filter cake subjected to the pressure dehydration is 8% to 15%, and preferably 10% to 12%; the filter cake of the dehydrated phosphogypsum is mechanically granulated with reducing pulverized coal and clay, and a stirring and kneading granulator is preferably used as a granulator.

5. The production method for producing the cement and co-producing the sulfuric acid from the phosphogypsum according to claim 2, wherein the pulping ratio of the phosphogypsum to the water in the pretreating and purifying is 1:2 to 4, and preferably 1:2.5; after the phosphogypsum slurry is subjected to the gravity separation, a total amount of separated coarse particles is 2% to 8%, and preferably 5%; the free water of the phosphogypsum filter cake subjected to the pressure dehydration is 8% to 15%, and preferably 10% to 12%; the filter cake of the dehydrated phosphogypsum is mechanically granulated with reducing pulverized coal and clay, and a stirring and kneading granulator is preferably used as a granulator.

6. The production method for producing the cement and co-producing the sulfuric acid from the phosphogypsum according to claim 1, wherein the reduction and decomposition integrated rotary kiln with fluidized preheating, drying and dehydration is an integral cylindrical steel-shell rotary kiln, the fluidized preheating, drying and dehydration section is provided with a special-type shoveling plate for lifting, so that the materials are shoveled when the rotary kiln rotates, and the materials are lifted from low to high along with the rotation, and after reaching a certain rotation angle, the materials start to be scattered gradually; the fluidized materials are heated by contacting with high-temperature gas reversely flowing in the kiln, dried and dehydrated, and meanwhile, the high-temperature gas is cooled by heat exchange; a setting area of the special-type shoveling plate for lifting is 0.2 L to 0.5 L, preferably 0.3 L to 0.4 L of a total length of the kiln; the special-type shoveling plates for lifting are capable of being respectively arranged at intervals of an a-type shoveling plate, a b-type shoveling plate, and a c-type shoveling plate, and preferably, the b-type shoveling plate and the c-type shoveling plate are arranged at an interval on a circumference; and refractory bricks are laid in the high-temperature reduction and decomposition section, and a setting area of the refractory bricks is 0.8 L to 0.5 L, and preferably 0.7 L to 0.6 L of the total length of the kiln.

7. The production method for producing the cement and co-producing the sulfuric acid from the phosphogypsum according to claim 2, wherein the reduction and decomposition integrated rotary kiln with fluidized preheating, drying and dehydration is an integral cylindrical steel-shell rotary kiln, the fluidized preheating, drying and dehydration section is provided with a special-type shoveling plate for lifting, so that the materials are shoveled when the rotary kiln rotates, and the materials are lifted from low to high along with the rotation, and after reaching a certain rotation angle, the materials start to be scattered gradually; the fluidized materials are heated by contacting with high-temperature gas reversely flowing in the kiln, dried and dehydrated, and meanwhile, the high-temperature gas is cooled by heat exchange; a setting area of the special-type shoveling plate for lifting is 0.2 L to 0.5 L, preferably 0.3 L to 0.4 L of a total length of the kiln; the special-type shoveling plates for lifting are capable of being respectively arranged at intervals of an a-type shoveling plate, a b-type shoveling plate, and a c-type shoveling plate, and preferably, the b-type shoveling plate and the c-type shoveling plate are arranged at an interval on a circumference; and refractory bricks are laid in the high-temperature reduction and decomposition section, and a setting area of the refractory bricks is 0.8 L to 0.5 L, and preferably 0.7 L to 0.6 L of the total length of the kiln.

8. The production method for producing the cement and co-producing the sulfuric acid from the phosphogypsum according to claim 3, wherein the reduction and decomposition integrated rotary kiln with fluidized preheating, drying and dehydration is an integral cylindrical steel-shell rotary kiln, the fluidized preheating, drying and dehydration section is provided with a special-type shoveling plate for lifting, so that the materials are shoveled when the rotary kiln rotates, and the materials are lifted from low to high along with the rotation, and after reaching a certain rotation angle, the materials start to be scattered gradually; the fluidized materials are heated by contacting with high-temperature gas reversely flowing in the kiln, dried and dehydrated, and meanwhile, the high-temperature gas is cooled by heat exchange; a setting area of the special-type shoveling plate for lifting is 0.2 L to 0.5 L, preferably 0.3 L to 0.4 L of a total length of the kiln; the special-type shoveling plates for lifting are capable of being respectively arranged at intervals of an a-type shoveling plate, a b-type shoveling plate, and a c-type shoveling plate, and preferably, the b-type shoveling plate and the c-type shoveling plate are arranged at an interval on a circumference; and refractory bricks are laid in the high-temperature reduction and decomposition section, and a setting area of the refractory bricks is 0.8 L to 0.5 L, and preferably 0.7 L to 0.6 L of the total length of the kiln.

9. The production method for producing the cement and co-producing the sulfuric acid from the phosphogypsum according to claim 1, wherein a temperature of the sulfur oxide gas discharged from a kiln tail of the reduction and decomposition rotary kiln after reduction and decomposition, fluidized preheating, drying, and dehydration is 320° C. to 400° C., and preferably 330° C. to 350° C.; a content of O₂ in the sulfur oxide gas is 0 to 1.0%, and preferably 0.2% to 0.6%; and a temperature of the high-temperature decomposition section of the reduction and decomposition rotary kiln is 1,000° C. to 1,300° C., and preferably 1,100° C. to 1,200° C.

10. The production method for producing the cement and co-producing the sulfuric acid from the phosphogypsum according to claim 3, wherein a temperature of the sulfur oxide gas discharged from a kiln tail of the reduction and decomposition rotary kiln after reduction and decomposition, fluidized preheating, drying, and dehydration is 320° C. to 400° C., and preferably 330° C. to 350° C.; a content of O₂ in the sulfur oxide gas is 0 to 1.0%, and preferably 0.2% to 0.6%; and a temperature of the high-temperature decomposition section of the reduction and decomposition rotary kiln is 1,000° C. to 1,300° C., and preferably 1,100° C. to 1,200° C.

11. The production method for producing the cement and co-producing the sulfuric acid from the phosphogypsum according to claim 5, wherein a temperature of the sulfur oxide gas discharged from a kiln tail of the reduction and decomposition rotary kiln after reduction and decomposition, fluidized preheating, drying, and dehydration is 320° C. to 400° C., and preferably 330° C. to 350° C.; a content of O₂ in the sulfur oxide gas is 0 to 1.0%, and preferably 0.2% to 0.6%; and a temperature of the high-temperature decomposition section of the reduction and decomposition rotary kiln is 1,000° C. to 1,300° C., and preferably 1,100° C. to 1,200° C.

12. The production method for producing the cement and co-producing the sulfuric acid from the phosphogypsum according to claim 1, wherein the material from a kiln head of the reduction and decomposition kiln directly enters the cement clinker sintering rotary kiln, a diameter of the sintering rotary kiln is 0.5 to 0.7 times, and preferably 0.4 to 0.6 times a diameter ϕ of the reduction and decomposition rotary kiln; a temperature of the high-temperature section of the cement clinker sintering kiln is 1,250° C. to 1,450° C., and preferably 1,300° C. to 1,350° C.; and a content of O₂ in outlet gas of the kiln tail of the cement clinker sintering kiln is 1.0% to 4.0%, and preferably 2.0% to 3.0%.

13. The production method for producing the cement and co-producing the sulfuric acid from the phosphogypsum according to claim 2, wherein the material from a kiln head of the reduction and decomposition kiln directly enters the cement clinker sintering rotary kiln, a diameter of the sintering rotary kiln is 0.5 to 0.7 times, and preferably 0.4 to 0.6 times a diameter ϕ of the reduction and decomposition rotary kiln; a temperature of the high-temperature section of the cement clinker sintering kiln is 1,250° C. to 1,450° C., and preferably 1,300° C. to 1,350° C.; and a content of O₂ in outlet gas of the kiln tail of the cement clinker sintering kiln is 1.0% to 4.0%, and preferably 2.0% to 3.0%.

14. The production method for producing the cement and co-producing the sulfuric acid from the phosphogypsum according to claim 3, wherein the material from a kiln head of the reduction and decomposition kiln directly enters the cement clinker sintering rotary kiln, a diameter of the sintering rotary kiln is 0.5 to 0.7 times, and preferably 0.4 to 0.6 times a diameter ϕ of the reduction and decomposition rotary kiln; a temperature of the high-temperature section of the cement clinker sintering kiln is 1,250° C. to 1,450° C., and preferably 1,300° C. to 1,350° C.; and a content of O₂ in outlet gas of the kiln tail of the cement clinker sintering kiln is 1.0% to 4.0%, and preferably 2.0% to 3.0%.

15. The production method for producing the cement and co-producing the sulfuric acid from the phosphogypsum according to claim 4, wherein the material from a kiln head of the reduction and decomposition kiln directly enters the cement clinker sintering rotary kiln, a diameter of the sintering rotary kiln is 0.5 to 0.7 times, and preferably 0.4 to 0.6 times a diameter ϕ of the reduction and decomposition rotary kiln; a temperature of the high-temperature section of the cement clinker sintering kiln is 1,250° C. to 1,450° C., and preferably 1,300° C. to 1,350° C.; and a content of O₂ in outlet gas of the kiln tail of the cement clinker sintering kiln is 1.0% to 4.0%, and preferably 2.0% to 3.0%.

16. The production method for producing the cement and co-producing the sulfuric acid from the phosphogypsum according to claim 5, wherein the material from a kiln head of the reduction and decomposition kiln directly enters the cement clinker sintering rotary kiln, a diameter of the sintering rotary kiln is 0.5 to 0.7 times, and preferably 0.4 to 0.6 times a diameter ϕ of the reduction and decomposition rotary kiln; a temperature of the high-temperature section of the cement clinker sintering kiln is 1,250° C. to 1,450° C., and preferably 1,300° C. to 1,350° C.; and a content of O₂ in outlet gas of the kiln tail of the cement clinker sintering kiln is 1.0% to 4.0%, and preferably 2.0% to 3.0%.

17. The production method for producing the cement and co-producing the sulfuric acid from the phosphogypsum according to claim 6, wherein the material from a kiln head of the reduction and decomposition kiln directly enters the cement clinker sintering rotary kiln, a diameter of the sintering rotary kiln is 0.5 to 0.7 times, and preferably 0.4 to 0.6 times a diameter ϕ of the reduction and decomposition rotary kiln; a temperature of the high-temperature section of the cement clinker sintering kiln is 1,250° C. to 1,450° C., and preferably 1,300° C. to 1,350° C.; and a content of O₂ in outlet gas of the kiln tail of the cement clinker sintering kiln is 1.0% to 4.0%, and preferably 2.0% to 3.0%.

18. The production method for producing the cement and co-producing the sulfuric acid from the phosphogypsum according to claim 7, wherein the cement clinker of the cement clinker sintering rotary kiln enters a cooler to be cooled from 1,150° C. to 110° C.-160° C., and preferably to 110° C.-130° C.

19. The production method for producing the cement and co-producing the sulfuric acid from the phosphogypsum according to claim 1, wherein hot air cooling the cement clinker from the cooler flows reversely to enter the cement clinker sintering rotary kiln, and hot air tail gas from the cement clinker sintering rotary kiln enters the integrated reduction and decomposition kiln, and is adjusted according to a system gas phase atmosphere.

20. The production method for producing the cement and co-producing the sulfuric acid from the phosphogypsum according to claim 3, wherein hot air cooling the cement clinker from the cooler flows reversely to enter the cement clinker sintering rotary kiln, and hot air tail gas from the cement clinker sintering rotary kiln enters the integrated reduction and decomposition kiln, and is adjusted according to a system gas phase atmosphere.
